(19) United States
(12) Patent Application Publication
(10) Pub. No.: US 2024/0313611 A1
(43) Pub. Date: Sep. 19, 2024

(54) ROTARY POWER TOOL

(71) Applicant: MILWAUKEE ELECTRIC TOOL CORPORATION, Brookfield, WI (US)

(72) Inventors: Ian A. DUNCAN, Colgate, WI (US); Christopher D. JORNLIN, Milwaukee, WI (US); Caleb M. SCHOBER, Milwaukee, WI (US)

(21) Appl. No.: 18/672,298

(22) Filed: May 23, 2024

Related U.S. Application Data
(63) Continuation of application No. 17/051,921, filed on Oct. 30, 2020, now Pat. No. 12,021,437.
(60) Provisional application No. 62/909,281, filed on Oct. 2, 2019.
(60) Provisional application No. 62/860,347, filed on Jun. 12, 2019.

(51) Int. Cl. H02K 5/24; B24B 23/02; B24B 41/00; B24B 47/12; B25F 5/00; B25F 5/02; H02K 7/04; H02K 7/08; H02K 7/14; H02K 9/06

(52) U.S. Cl. CPC H02K 5/24; B24B 41/007; B24B 47/12; B25F 5/006; B25F 5/02; H02K 7/04; H02K 7/083; H02K 7/145; H02K 9/06; B24B 23/02

(57) ABSTRACT

A power tool includes a motor housing extending along a first axis, a motor positioned in the motor housing, a handle extending along a second axis perpendicular to the first axis, and a vibration damping assembly positioned between the motor housing and the handle. The vibration damping assembly includes a first coupling portion defined by the motor housing, a second coupling portion defined by the handle, and an elastomeric damper captured between the first coupling portion and the second coupling portion. The first coupling portion includes a first mating surface facing toward the handle, and the second coupling portion includes a second mating surface facing toward the motor housing and positioned opposite the first mating surface. The damper includes a mating surface portion that extends outward in a direction transverse to the second axis, and the mating surface portion is positioned between the first and second mating surfaces.

### CROSS-REFERENCE TO RELATED APPLICATIONS

This application is a continuation of co-pending U.S. patent application Ser. No. 17/051,921, filed Oct. 30, 2020, which is a national stage entry of International Application No. PCT/US2020/037546, filed Jun. 12, 2020, which claims priority to U.S. Provisional Patent Application No. 62/909,281, filed Oct. 2, 2019, and to U.S. Provisional Patent Application No. 62/860,347, filed Jun. 12, 2019, the entire contents of all of which are incorporated herein by reference.

### FIELD OF THE INVENTION

The present invention relates to power tools, and more particularly to portable rotary power tools.

### BACKGROUND OF THE INVENTION

Many of the portable grinding tools currently available that run at high operating speeds (e.g., 20,000 revolutions per minute (rpm) or greater) are pneumatic tools. Pneumatic motors powering these tools typically have very short output shafts that do not produce significant vibrations such high operating speeds (e.g., from 20,000 to 24,000 rpm). Electric motors, however, typically have a longer rotor shaft and output shaft. Due to the dimensions and the flexibility of this longer shaft, at high operating speeds the shaft tends to have resonant vibrations that shake the tool.

### SUMMARY OF THE INVENTION

The present invention provides, in one aspect, a power tool including a motor housing extending along a first axis, a motor positioned in the motor housing and configured to rotatably drive an output shaft, and a handle coupled to the motor housing and extending along a second axis perpendicular to the first axis. The power tool also includes a vibration damping assembly positioned between the motor housing and the handle, the vibration damping assembly including a first coupling portion defined by the motor housing, a second coupling portion defined by the handle, and an elastomeric damper captured between the first coupling portion and the second coupling portion. The first coupling portion includes a boss, and the second coupling portion defines an opening configured to receive the boss. The first coupling portion includes a first mating surface facing toward the handle, and the second coupling portion includes a second mating surface facing toward the motor housing and positioned opposite the first mating surface. The damper includes a mating surface portion that extends outward in a direction transverse to the second axis, and the mating surface portion is positioned between the first and second mating surfaces.

The present invention provides, in another aspect, a power tool including a motor housing extending along a first axis, and a handle extending along a second axis perpendicular to the first axis. The power tool also includes a motor positioned in the motor housing, the motor including a stator supported within the motor housing, a rotor shaft defining a motor axis coaxial with the first axis, and a rotor supported on the rotor shaft for rotation about the motor axis. A portion of the rotor shaft defines an output shaft that extends outward from the motor housing, and a distal end of the output shaft is configured to couple to a tool holder configured to receive a cutting tool.

The present invention provides, in yet another aspect, a power tool including a housing defining a longitudinal housing axis, and a motor positioned in the housing. The power tool also includes a battery receptacle defined by the housing, the battery receptacle being configured to receive a battery pack insertable into the housing in a direction along the longitudinal axis. The power tool also includes a low friction wear member coupled to the housing proximate the battery receptacle. When the battery pack is inserted into the battery receptacle, the battery pack contacts and engages the low friction wear member to prevent abrasion between the housing and the battery pack.

Other features and aspects of the invention will become apparent by consideration of the following detailed description and accompanying drawings.

### BRIEF DESCRIPTION OF THE DRAWINGS

FIG. 1 is a perspective view of a portable rotary power tool, such as a die grinder.

FIG. 2 is another perspective view of the die grinder of FIG. 1.

FIG. 3 is a plan view of the die grinder of FIG. 1.

FIG. 4 is another plan view of the die grinder of FIG. 1.

FIG. 5 is another plan view of the die grinder of FIG. 1, with portions removed.

FIG. 6 is a partially exploded perspective view of the die grinder of FIG. 1, showing a motor housing, a handle, and an elastomeric damper.

FIG. 7 is another partially exploded perspective view of the die grinder of FIG. 1.

FIG. 8 is a perspective view of the motor housing of FIG. 6.

FIG. 9 is another perspective view of the motor housing of FIG. 6, with portions removed.

FIG. 10 is a perspective view of the handle of FIG. 6.

FIG. 11 is another perspective view of the handle of FIG. 6, with portions removed.

FIGS. 12 and 13 are perspective views of the elastomeric damper of FIG. 6.

FIG. 14 is a cross-sectional view of the die grinder of FIG. 1, taken along line 14-14 of FIG. 2.

FIG. 15 is a detailed cross-sectional view of a portion of the die grinder of FIG. 1, taken along line 14-14 of FIG. 2.

FIG. 16 is another cross-sectional view of the die grinder of FIG. 1, taken along line 16-16 of FIG. 3.

FIG. 17 is a detailed cross-sectional view of a portion of the die grinder of FIG. 1, taken along line 16-16 of FIG. 3.

FIG. 18 is another cross-sectional view of the die grinder of FIG. 1, taken along line 18-18 of FIG. 3.

FIG. 19 is another cross-sectional view of the die grinder of FIG. 1, taken along line 19-19 of FIG. 3.

FIG. 20 is a perspective view of the die grinder of FIG. 1, with portions removed.

FIG. 21 is a detailed perspective view of a battery receptacle of the die grinder of FIG. 1 with portions removed.

FIG. 22 is a perspective view of a portable rotary power tool, such as a die grinder.

FIG. 23 is a partially exploded perspective view of the die grinder of FIG. 22, showing a motor housing, a handle, and an elastomeric damper.

FIGS. 24 and 25 are perspective views of the elastomeric damper of FIG. 23.

FIG. 26 is a detailed cross-sectional view of a portion of the die grinder of FIG. 22, taken along line 26-26 of FIG. 22.

FIG. 27 is a detailed cross-sectional view of a portion of the die grinder of FIG. 22, taken along line 27-27 of FIG. 22.

FIG. 28 is a plan view of a rotor assembly of the die grinders of FIGS. 1 and 22.

FIG. 29 is a cross-sectional view of the rotor assembly of FIG. 28, taken along line 29-29 of FIG. 28.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

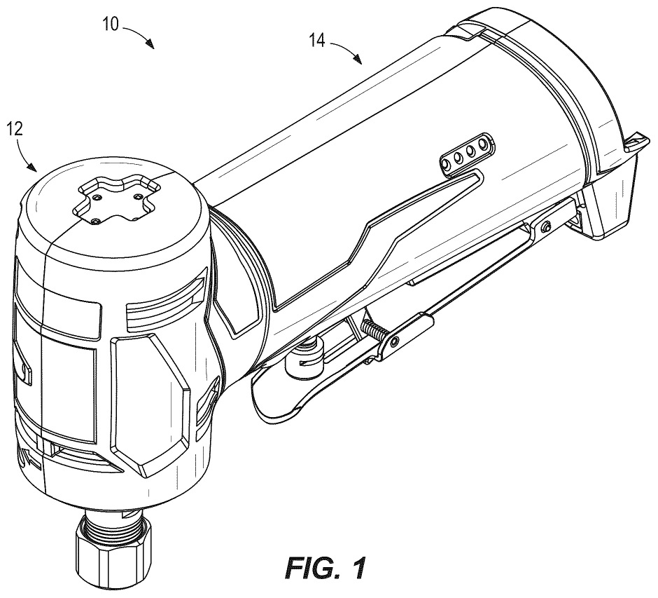

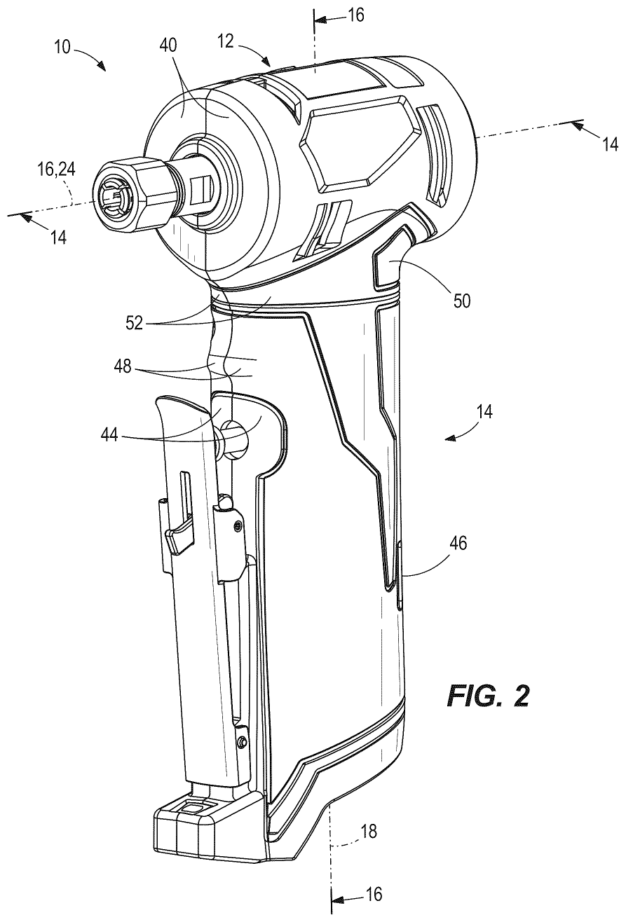

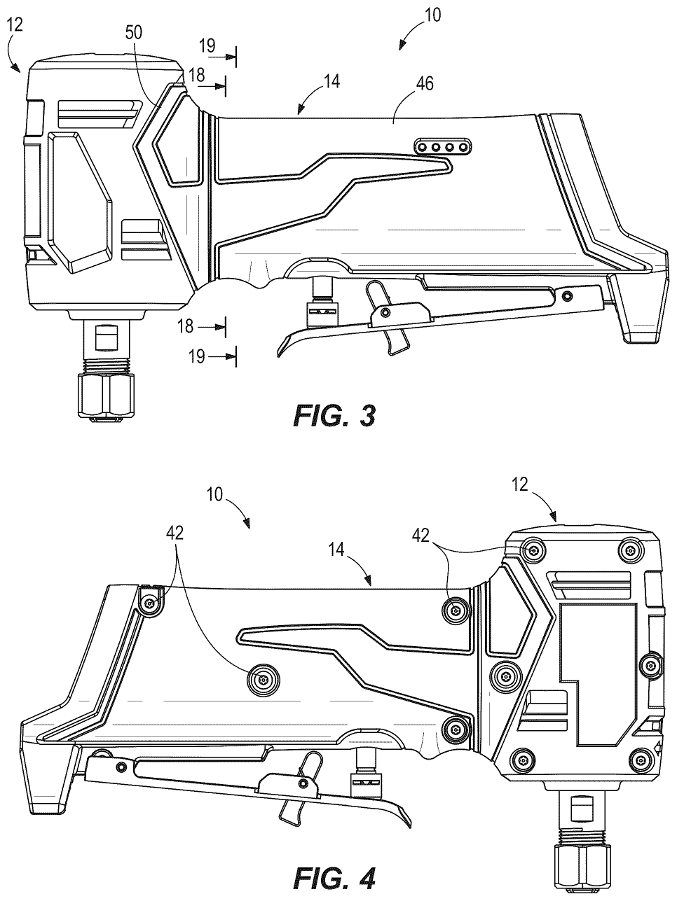

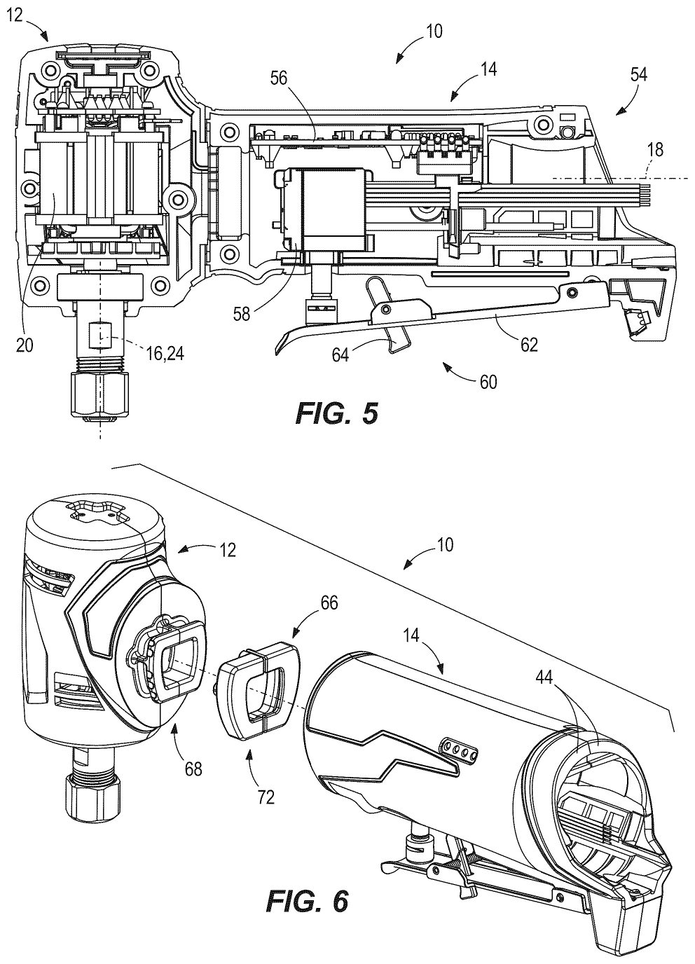

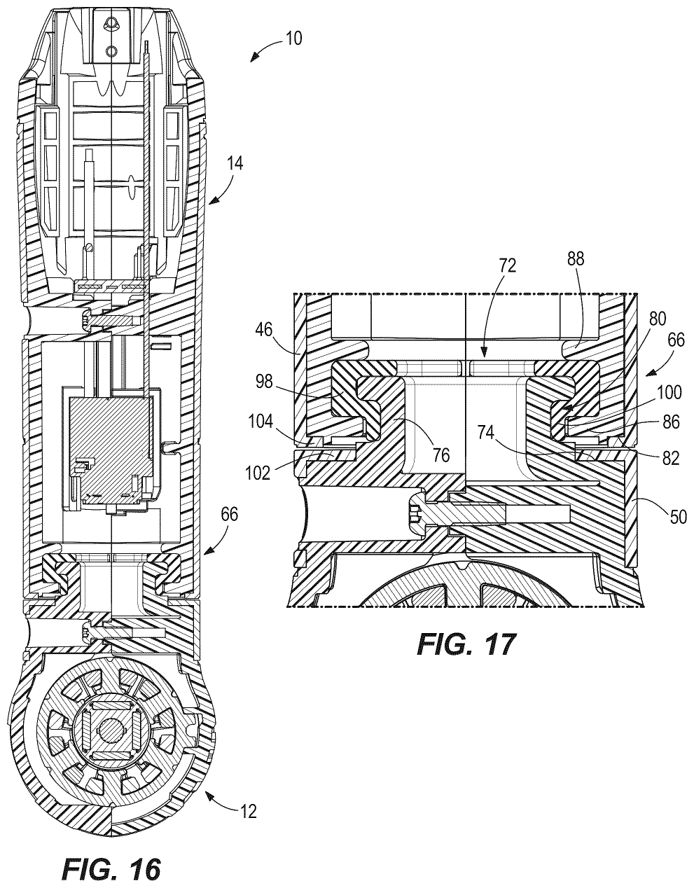

FIGS. 1-21 illustrate a portable powered grinding tool, such as a die grinder 10, according to an embodiment of the invention. As shown in FIGS. 1 and 2, the die grinder 10 includes a motor housing 12 and a handle 14 extending transversely from the motor housing 12. The motor housing 12 extends along a first axis 16, and the handle 14 extends along a second axis 18 which is transverse to the first axis 16. A motor 20 (FIG. 5) is located within the motor housing 12. The motor 20 includes a rotor shaft 22 extending longitudinally therethrough and defining a motor axis 24. In the illustrated embodiment, the first axis 16 is coaxial with the motor axis 24.

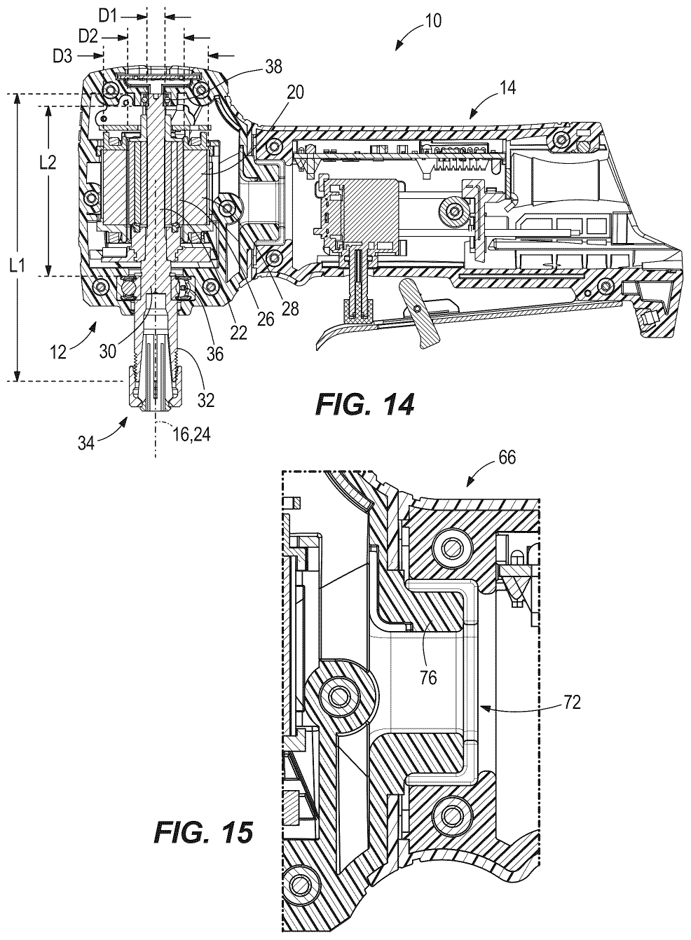

With reference to FIG. 14, the motor 20 also includes a rotor 26 and a stator 28 that surrounds the rotor 26. The stator 28 is supported within the motor housing 12 and remains stationary relative to the housing 14 during operation of the grinder 10. The rotor 26 is rotatably fixed to the rotor shaft 22 and configured to co-rotate with the rotor shaft 22, relative to the stator 28, about the motor axis 24. A portion of the rotor shaft 22 defines an output shaft 30 extending from the motor housing 12. A distal end 32 of the output shaft 30 is coupled to a tool holder 34 configured to receive a cutting tool (e.g., a grinding disc, a rotary burr, etc.).

The rotor shaft 22 is rotatably supported by first and second bearings 36, 38 coupled to the motor housing 12 and located adjacent opposite ends of the rotor 26. The first bearing 36 is positioned proximate the output shaft 30, and the second bearing 38 is positioned opposite the first bearing 36 with respect to the rotor 26. During operation of the grinder 10, the rotor shaft 22 is configured to rotate at speeds above 20,000 rpm (e.g., 24,500 rpm).

With continued reference to FIG. 14, in the illustrated embodiment, the rotor shaft 22 defines a shaft diameter D1 of approximately 6 millimeters (mm), the rotor 26 defines a rotor outside diameter D2 of approximately 18 mm, and the stator 28 defines a stator outside diameter D3 of approximately 36 mm. Providing the rotor shaft 22 with a shaft diameter D1 of 6 mm improves fatigue failure as compared to smaller diameter shafts, and allows the rotor shaft 22 to rotate at speeds greater than 20,000 rpm without failure. A housing head diameter D4 (FIG. 8) of a portion of the motor housing 12 surrounding the stator 28 is approximately 50.8 mm. The rotor shaft 22 defines a shaft length L1 of approximately 95.5 mm, measured from end to end along the first axis 16 (FIG. 14). The rotor shaft 22 further includes a bearing span L2 of approximately 57 mm, measured along the length of the rotor shaft 22 between the first and second bearings 36, 38.

In the illustrated embodiment, a first ratio R1 is defined as the ratio of the rotor outside diameter D2 to the rotor shaft diameter D1 (i.e., D2:D1). The first ratio R1 is 3:1. A second ratio R2 is defined as the ratio of the stator outside diameter D3 to the rotor shaft diameter D1 (i.e., D3:D1). The second ratio R2 is 6:1. A third ratio R3 is defined as the ratio of the bearing span L2 to the rotor shaft diameter D1 (i.e., L2:D1). The third ratio R3 is 9.5:1.

With reference to FIGS. 2-4, the motor housing 12 includes a pair of motor half housings 40 coupled together via fasteners 42. The handle 14 likewise includes a pair of handle half housings 44 coupled together via fasteners 42. A grip 46 is overmolded on the handle 14 and divided into a pair of grip portions 48 adhered to each respective handle half housing 44. Similarly, a cover 50 is overmolded on the motor housing 12 and divided into a pair of cover portions 52 adhered to each respective motor half housing 40. The motor half housings 40 and the handle half housings 44 are formed of a relatively hard plastic material (e.g., ABS, PA, PP, PC, etc.), whereas the overmolded grip 46 and cover 50 are each formed from a relatively softer material (e.g., a thermoplastic elastomer, rubber, etc.).

With reference to FIG. 5, the handle 14 defines a battery receptacle 54, which is positioned on an end of the handle 14 opposite the motor housing 12. The battery receptacle 54 is configured to selectively mechanically and electrically connect to a rechargeable battery pack (not shown) for powering the motor 20 (FIG. 14). The battery pack is insertable into the battery receptacle 54 such that, when inserted, the battery pack may be oriented along the second axis 18. Alternatively, in another embodiment of the die grinder 10, the battery pack may be slidably coupled to the battery receptacle along an axis that is transverse to the second axis 18. The battery pack may include any of a number of different nominal voltages (e.g., 12V, 18V, etc.), and may be configured having any of a number of different chemistries (e.g., lithium-ion, nickel-cadmium, etc.). In alternative embodiments (not shown), the motor 20 may be powered by a remote power source (e.g., a household electrical outlet) through a power cord. The handle 14 further contains control electronics for the grinder 10 (e.g., a PCBA 56, a microswitch 58, etc.).

The handle 14 supports a trigger assembly 60 operable to selectively electrically connect the power source (e.g., the battery pack) and the motor 20. The trigger assembly 60 is a “lock-off” trigger assembly having a paddle member 62 and a lock-off member 64 supported by the paddle member 62. The paddle member 62 is operable to actuate the microswitch 58 (FIG. 5) to selectively activate and deactivate the motor 20 during operation of the die grinder 10. The lock-off member 64 selectively prevents operation of the paddle member 62. Specifically, the lock-off member 64 is pivotable to selectively lock and unlock the paddle member 62.

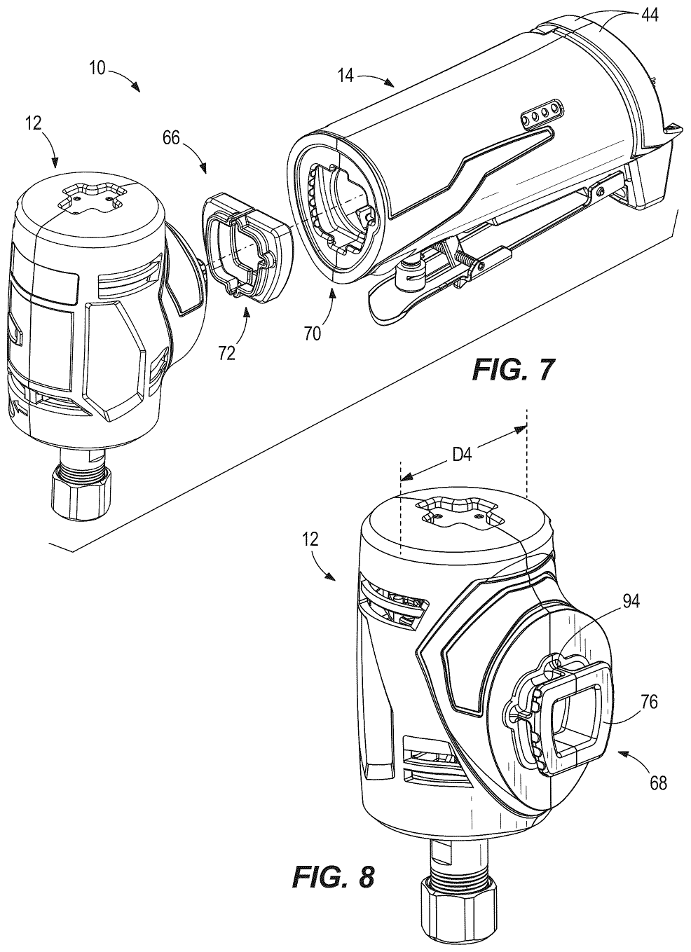

With reference to FIGS. 6 and 7, the grinder 10 includes a vibration damping assembly 66 positioned between the motor housing 12 and the handle 14 to attenuate vibration from the motor housing 12. The damping assembly 66 includes a first coupling portion 68 defined by the motor housing 12, a second coupling portion 70 defined by the handle 14, and an elastomeric damper 72 positioned between the first and second coupling portions 68, 70. In the illustrated embodiment, the damper 72 is overmolded to the first coupling portion 68 of the motor housing 12, and then captured on its outer periphery by the second coupling portion 70 of the assembled half housings 44 of the handle 14.

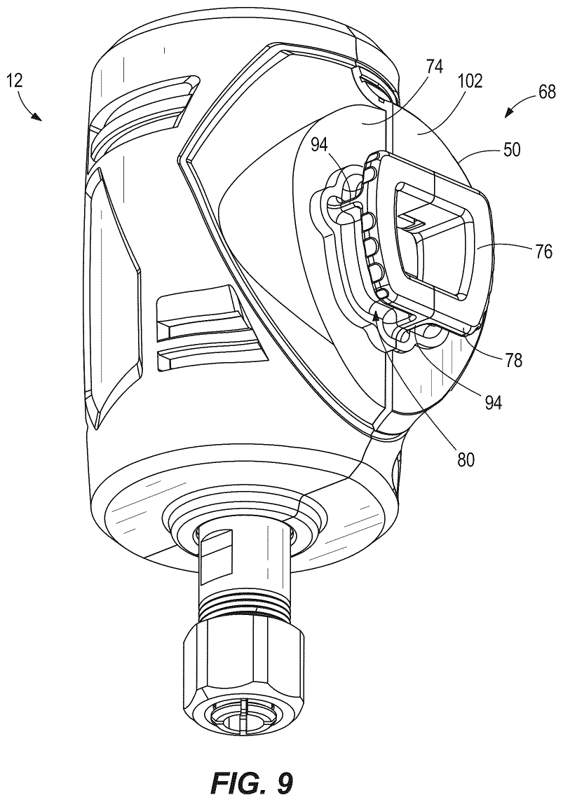

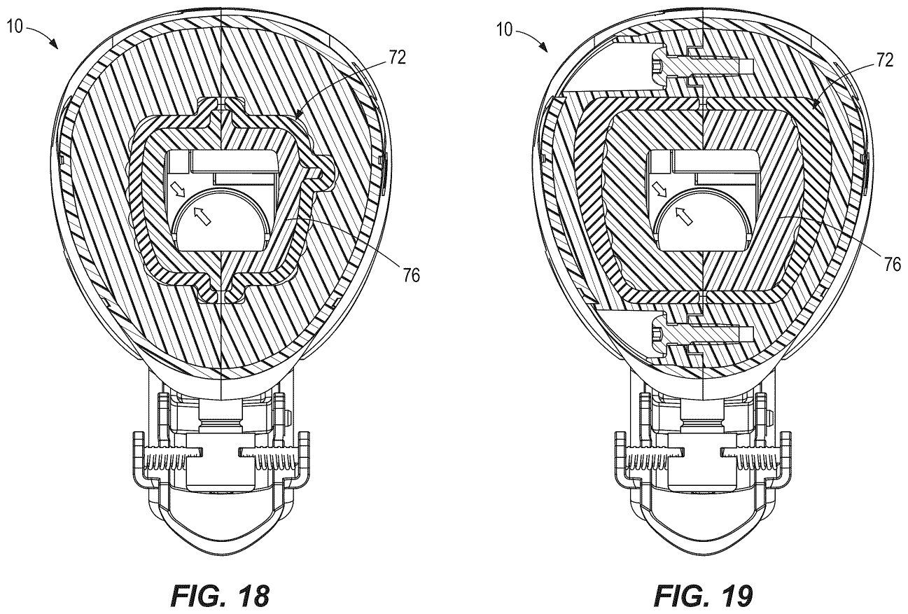

With reference to FIGS. 8 and 9, the first coupling portion 68 includes a flat first mating surface 74 facing toward the handle 14 in the assembled grinder 10, and a boss 76 extending from the first mating surface 74 toward the handle 14 in a direction generally along the second axis 18. The boss 76 terminates in a flange 78 that extends outward from the boss 76 in a direction generally transverse to the second axis 18 (i.e., in a radial direction). The first coupling portion 68 further includes a first groove 80 that circumscribes the boss 76 between the flange 78 and the first mating surface 74. In the illustrated embodiment, the boss 76 has a generally square cross-sectional shape as shown in FIGS. 18 and 19. In other embodiments (not shown), the boss 76 may have another cross-sectional shape (e.g., circular, rectangular, annular, conical, triangular, etc.).

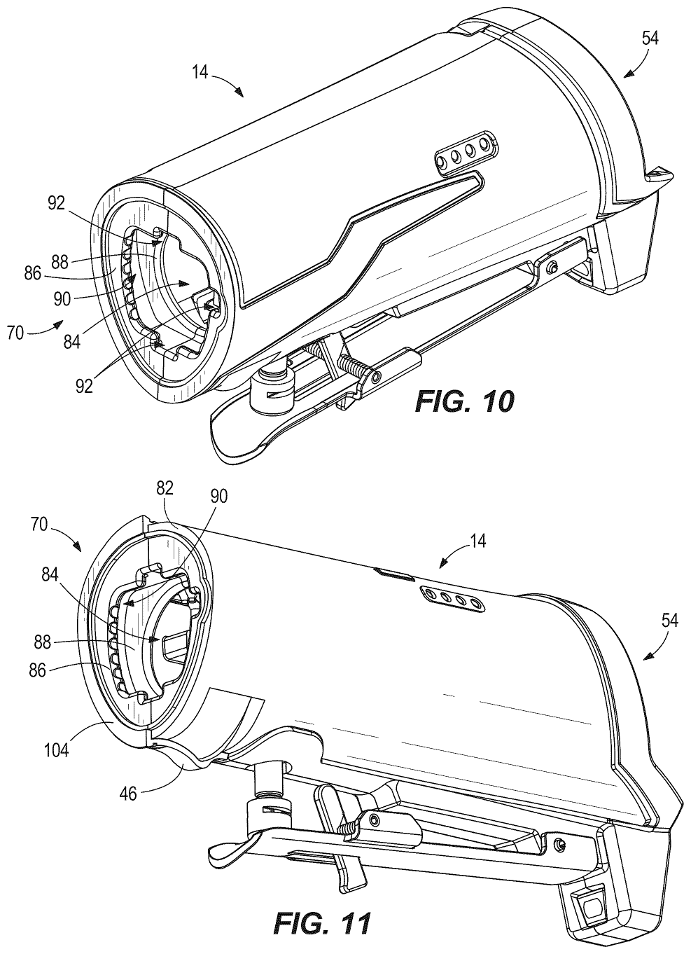

With respect to FIGS. 10 and 11, the second coupling portion 70 includes a flat second mating surface 82 facing toward the motor housing 12 and positioned opposite the first mating surface 74 in the assembled grinder 10. The second coupling portion 70 further defines an opening 84 extending from the second mating surface 82 toward the battery receptacle 54 along the second axis 18. The opening 84 is configured to receive the boss 76, such that the boss 76 is captured by the second coupling portion 70. The second coupling portion 70 further includes a first rib 86 and a second rib 88 spaced apart from one another along the second axis 18, with each rib 86, 88 extending inward toward an interior of the handle 14 in a direction generally transverse to the second axis 18 (i.e., in a radial direction). A second groove 90 is defined between the first and second ribs 86 and 88. Locating grooves 92 are defined in the first rib 86, and corresponding locating ribs 94 (FIGS. 9 and 10) are formed on the boss 76. The locating ribs 94 are received into the locating grooves 92 to properly orient the handle 14 with respect to the motor housing 12.

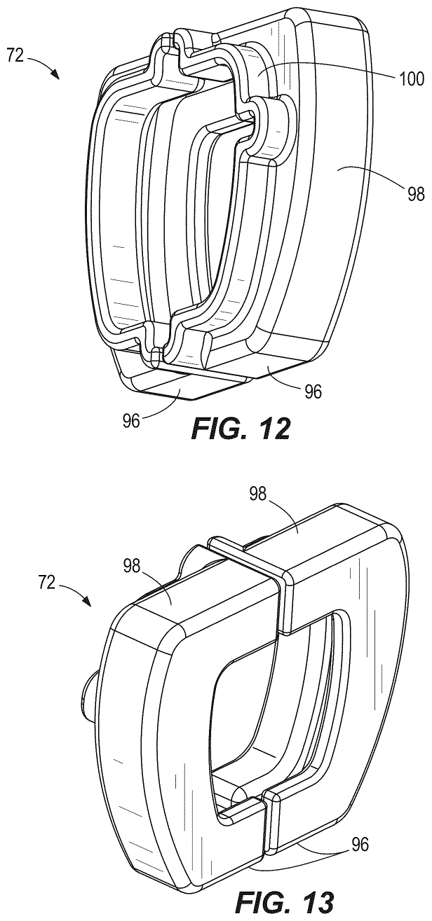

The damper 72 is overmolded to the boss 76. With reference to FIGS. 12 and 13, in the illustrated embodiment, the damper 72 is divided into two damper halves 96 corresponding to the two respective motor half housings 40. In other embodiments, the damper 72 may be molded separately from the motor housing 12 and subsequently coupled to the boss 76. In the same or other embodiments, the damper 72 may include a unitary construction, such that the damper is formed as a single piece. The damper 72 is formed of a softer material than that of the motor housing 12 and the handle 14, such as, e.g., rubber or a thermoplastic elastomer. In the illustrated embodiment, the damper 72 is formed of NBR (Buna N) and is configured to damp vibration from the motor housing 12 and limit transmission of the vibration from the motor housing 12 to the handle 14 and thus to a user's hand.

With continued reference to FIGS. 12 and 13, in the illustrated embodiment, each damper half 96 includes a flange portion 98 that surrounds the flange 78 (FIG. 9) of the boss 76, and a groove portion 100 extending in a direction along the second axis 18 and configured to seat into the first groove 80 (FIG. 9) of the boss 76. When the handle 14 is coupled to the motor housing 12, the flange portion 98 of each damper half 96 is received into the second groove 90 (FIG. 17) of the second coupling portion 70 and captured between the flange 78 and the second groove 90. Meanwhile, the groove portion 100 is captured between the first groove 80 (FIG. 17) and the first rib 86.

With reference to FIGS. 9, 11, and 17, the overmolded cover 50 includes a first lip 102 that wraps over the first mating surface 74 of the first coupling portion 68. Likewise, the overmolded grip 46 includes a second lip 104 that wraps over the second mating surface 82 of the second coupling portion 70. In the assembled grinder 10, the first and second lips 102, 104 abut one another and are positioned between the first and second mating surfaces 74, 82. The first and second lips 102, 104 form an additional component of the damping assembly 66 and are configured to further attenuate the transmission of vibrations from the motor housing 12 to the handle 14 during operation of the grinder 10.

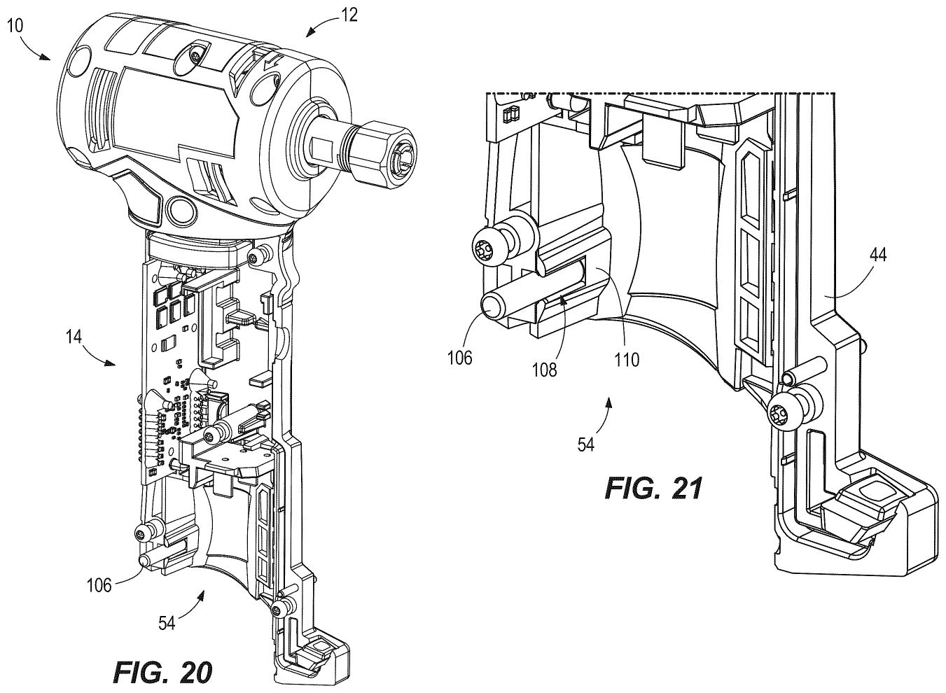

With reference to FIGS. 20 and 21, the die grinder 10 also includes a low friction wear member 106 positioned in a slot or recess 108 (e.g, by a nominal clearance fit) within an inner face 110 of the battery receptacle 54. The low friction wear member 106 is positioned where the battery contacts the receptacle 54 and configured as a rod 106 composed of PTFE. In other embodiments, the wear member 106 may alternatively be composed of, for example, polytetrafluoroethylene (PTFE or Teflon) or a thermoplastic elastomer (TPE). The wear member 106 provides a low friction surface against which the battery can slide to prevent abrasion and welding between the tool handle 14 and the battery, including under high vibration. In the illustrated embodiment, the recess 108 is defined in portions of each handle half housing 44, such that the wear member 106 is captured in the recess 108 between the two handle half housings 44.

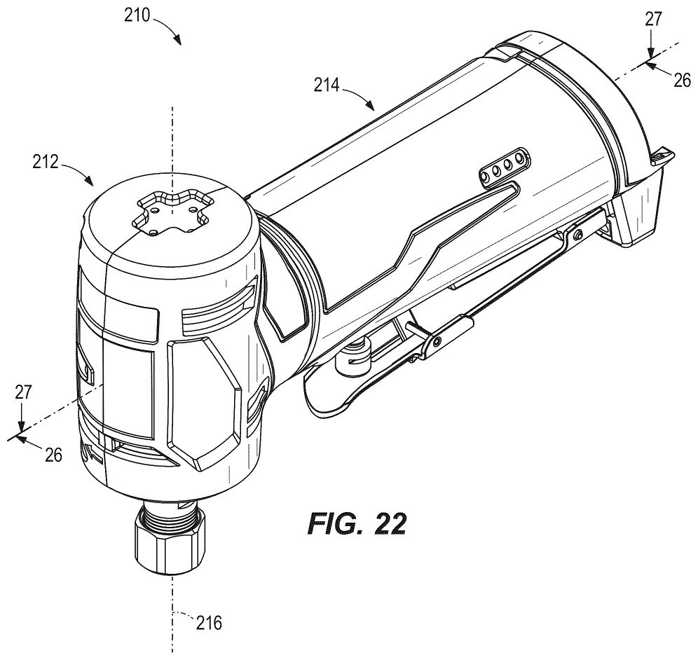

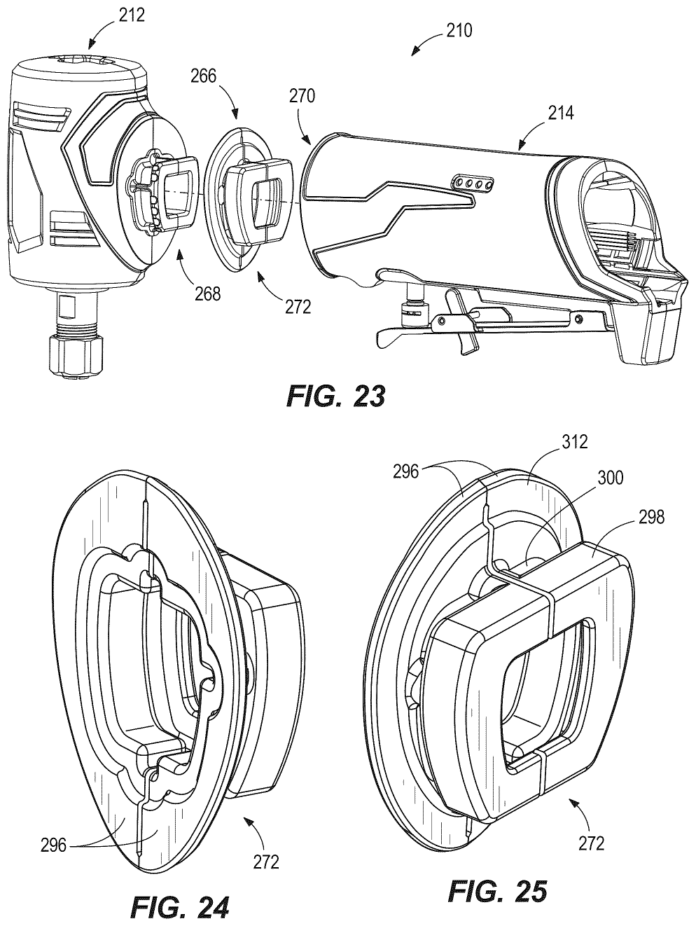

FIGS. 22-27 illustrate a die grinder 210 according to another embodiment of the invention. The die grinder 210 is similar to the die grinder 10 and includes substantially the same structure as the die grinder 10. Accordingly, the following description focuses primarily on the structure and features that are different from the embodiments described above in connection with FIGS. 1-21. Features and elements that are described in connection with FIGS. 1-21 are numbered in the 200 and 300 series of reference numbers in FIGS. 22-27. It should be understood that the features of the die grinder 210 that are not explicitly described below have the same properties as the features of the die grinder 10.

With reference to FIGS. 22-25, the grinder 210 includes a vibration damping assembly 266 positioned between the motor housing 212 and the handle 214 to attenuate vibration from the motor housing 212. The damping assembly 266 includes a first coupling portion 268 defined by the motor housing 212, a second coupling portion 270 defined by the handle 218, and an elastomeric damper 272 positioned between the first and second coupling portions 268, 270. The first and second coupling portions 268, 270 are substantially the same as the first and second coupling portions 68, 70 described above. In the illustrated embodiment, the damper 272 is overmolded to the first coupling portion 268 of the motor housing 212, and then captured on its outer periphery by the second coupling portion 270 of the assembled half housings 244 of the handle 214.

Like the damper 72 described above, the damper 272 is divided into two damper halves 296 corresponding to the two respective motor half housings 240. The damper 272 likewise includes a flange portion 298 corresponding to the flange 278 of the first coupling portion 268, and a groove portion 300 extending in a direction along the second axis 18 and configured to seat into the first groove 280 of the boss 276. The damper 272 further includes a mating surface portion 312 that extends outward from the groove portion 300 in a direction generally transverse to the second axis 18 (i.e., in a radial direction). The groove portion 300 extends away from the flange portion 298 and terminates in the mating surface portion 312, such that the mating surface portion 312 is located opposite the flange portion 298 with respect to the grove portion 300.

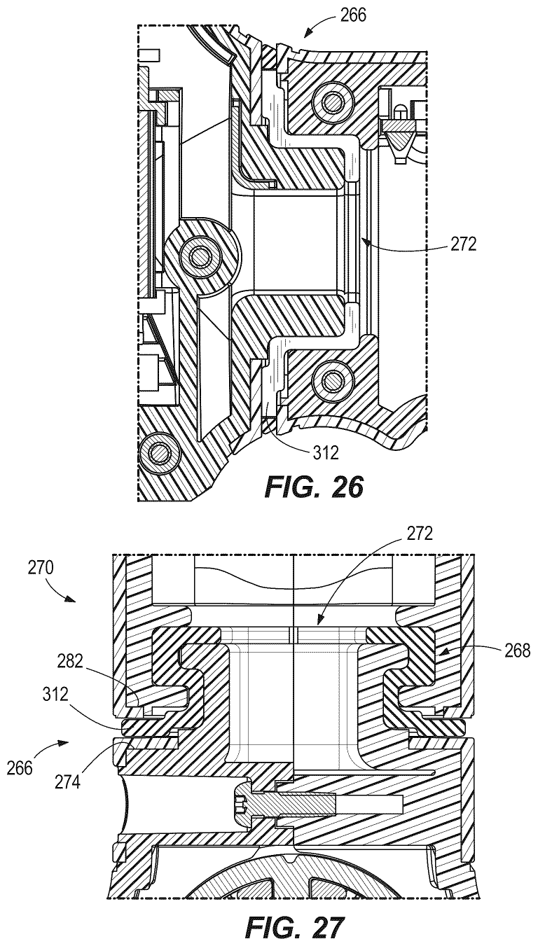

With reference to FIGS. 26 and 27, the mating surface portion 312 corresponds to the first and second mating surfaces 274, 282 of the first and second coupling portions 268, 270. Specifically, in the assembled grinder 210, the mating surface portion 312 is positioned between the first and second mating surfaces 274, 282 and further attenuates vibrations transferred from the motor housing 212 to the handle 214.

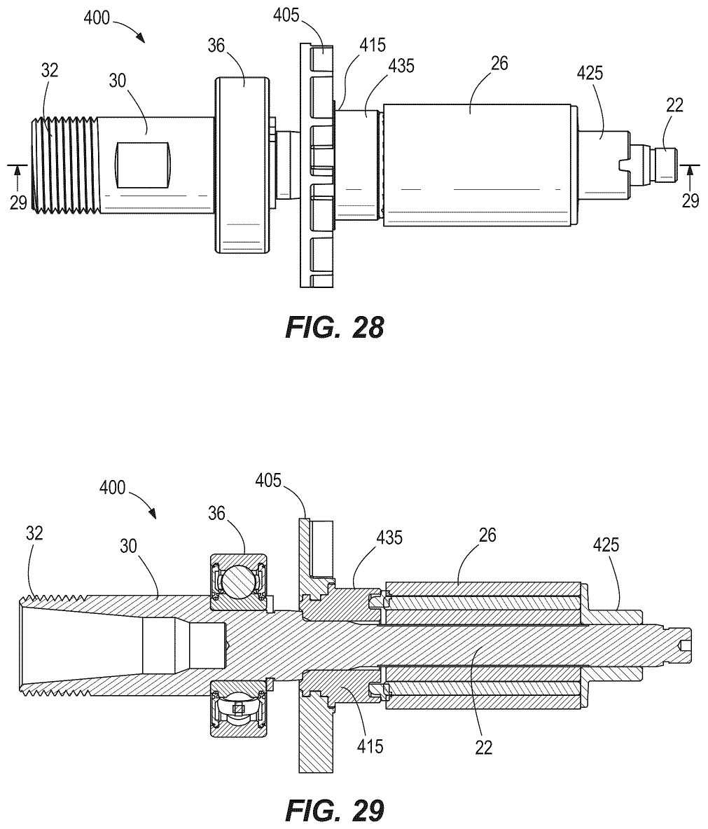

FIG. 28 illustrates a rotor assembly 400 for use in either of the die grinders 10, 210. Although the rotor assembly 400 is described herein in terms of the reference numerals associated with the die grinder 10, it should be understood that the rotor assembly 400 is equally applicable to the die grinder 210. The rotor assembly 400 includes the rotor 26, the rotor shaft 22, the first bearing 36, a fan 405, and first and second bushings 415, 425. As discussed above, a portion of the rotor shaft 22 defines the output shaft 30 that couples to the tool holder 34 (e.g., a collet and nut assembly; FIG. 14) at the distal end 32. By forming the rotor shaft 22 integrally with the output shaft 30, the die grinders 10, 210 avoid the need for an additional coupler between the rotor shaft 22 and the output shaft 30. This reduces the length of the rotor assembly 400, and allows the motor 20 to be arranged in-line with the output shaft 30. This further allows the motor axis 24 (FIG. 2) to be arranged transverse to the first axis 16, as discussed above.

With reference to FIGS. 28 and 29, in the illustrated embodiment of the rotor assembly 400, the first bushing 415 is affixed to the rotor shaft 22 adjacent the rotor 26. The fan 405 is supported on the first bushing 415 such that the first bushing 415 couples the fan 405 to the rotor shaft 22. The first bushing 415 further includes a balancing portion 435 that extends axially away from the fan 405. In other embodiments of the rotor assembly 400, the fan 405 may be coupled directly to the rotor shaft 22 rather than indirectly via the first bushing 415.

During assembly of the die grinders 10, 210, the rotor assembly 400 is assembled as described above and as shown in FIG. 28. Once assembled, the rotor assembly 400 is rotatably balanced to eliminate or reduce vibration that may otherwise occur as the rotor assembly 400 rotates during operation of the die grinders 10, 210. In some embodiments of the die grinders 10, 210, the rotor assemblies may be balanced by removing material from a back side of the fan 405. However, when the illustrated rotor assembly 400 is assembled, access to the fan 405 can be difficult due to the proximity of the rotor 26 and the first bearing 36. Moreover, material shavings removed from the fan 405 could potentially ingress into the first bearing 36.

In the illustrated embodiment, the rotor assembly 400 can be balanced by removing material from the balancing portion 435 of the first bushing 415. In this regard, the first bushing 415 may be made from a relatively heavy material such as metal (e.g., copper). In some embodiments, material can be removed from the balancing portion 435 by drilling into the balancing portion 435 in a radial direction as indicated by the arrow shown in FIG. 28. Since the balancing portion 435 of the first bushing 415 is more easily accessed than the back side of the fan 405, this reduces the risk that other components of the rotor assembly 400 are inadvertently contacted during the drilling step. This also reduces the likelihood that material shavings removed during the drilling process ingress into the first bearing 36, which is shielded in an axial direction by the fan 405.

Various features of the invention are set forth in the following claims.

What is claimed is:

1. A power tool comprising:
a motor housing extending along a first axis;
a motor positioned in the motor housing and configured to rotatably drive an output shaft;
a handle coupled to the motor housing and extending along a second axis perpendicular to the first axis; and
a vibration damping assembly positioned between the motor housing and the handle, the vibration damping assembly including a first coupling portion defined by the motor housing, a second coupling portion defined by the handle, and an elastomeric damper captured between the first coupling portion and the second coupling portion;
wherein:
the first coupling portion includes a boss;
the second coupling portion defines an opening configured to receive the boss;
the first coupling portion includes a first mating surface facing toward the handle;
the second coupling portion includes a second mating surface facing toward the motor housing and positioned opposite the first mating surface;
the damper includes a mating surface portion that extends outward in a direction transverse to the second axis; and
the mating surface portion is positioned between the first and second mating surfaces.

2. The power tool of claim 1, wherein the boss terminates in a flange that extends outward from the boss in a direction transverse to the second axis.

3. The power tool of claim 2, wherein the first coupling portion further includes a first groove that circumscribes the boss between the flange and the first mating surface.

4. The power tool of claim 1, wherein the damper is overmolded to the first coupling portion.

5. The power tool of claim 1, wherein the second coupling portion includes a first rib and a second rib.

6. The power tool of claim 5, wherein the first rib and the second rib are spaced apart from one another along the second axis.

7. The power tool of claim 1, further comprising:
a cover overmolded on the motor housing; and
a grip overmolded on the handle,
wherein the overmolded cover includes a first lip that wraps over the first mating surface,
wherein the grip includes a second lip that wraps over the second mating surface, and
wherein the mating surface portion of the damper extends between the first lip and the second lip.

8. A power tool comprising:
a motor housing extending along a first axis;
a handle extending along a second axis perpendicular to the first axis; and
a motor positioned in the motor housing, the motor including a stator supported within the motor housing, a rotor shaft defining a motor axis coaxial with the first axis, and a rotor supported on the rotor shaft for rotation about the motor axis;
wherein a portion of the rotor shaft defines an output shaft that extends outward from the motor housing, and a distal end of the output shaft is configured to couple to a tool holder configured to receive a cutting tool.

9. The power tool of claim 8, wherein the rotor shaft defines a rotor shaft outside diameter D1, wherein the rotor defines a rotor outside diameter D2, and wherein a ratio R1 of the rotor outside diameter D2 to the rotor shaft outside diameter D1 is less than or equal to 3.

10. The power tool of claim 9, wherein the rotor shaft outside diameter D1 is at least 6 millimeters.

11. The power tool of claim 8, wherein the rotor shaft defines a rotor shaft outside diameter D1, wherein the stator defines a stator outside diameter D3, and wherein a ratio R2 of the stator outside diameter D3 to the rotor shaft outside diameter D1 is less than or equal to 6.

12. The power tool of claim 11, wherein the rotor shaft outside diameter D1 is at least 6 millimeters, and wherein the stator outside diameter D3 is no greater than 36 millimeters.

13. The power tool of claim 8, further comprising a first rotor bearing and a second rotor bearing located at opposite respective ends of the rotor and rotatably supporting the rotor shaft, each of the first and second rotor bearings supported by the motor housing;
wherein:
the rotor shaft defines a rotor shaft outside diameter D1;
the rotor shaft defines a bearing span L2 measured between the first rotor bearing and the second rotor bearing; and
a ratio R3 of the bearing span L2 to the rotor shaft outside diameter D1 is less than or equal to 9.5.

14. The power tool of claim 13, wherein the rotor shaft outside diameter D1 is at least 6 millimeters, and wherein the bearing span L2 is no greater than 57 millimeters.

15. The power tool of claim 8, further comprising a vibration damping assembly positioned between the motor housing and the handle, the vibration damping assembly including a first coupling portion defined by the motor housing, a second coupling portion defined by the handle, and an elastomeric damper captured between the first coupling portion and the second coupling portion.

16. The power tool of claim 8, further comprising:
a first rotor bearing and a second rotor bearing located at opposite respective ends of the rotor and rotatably supporting the rotor shaft, each of the first and second rotor bearings supported by the motor housing;
a bushing affixed to the rotor shaft between the rotor and the first rotor bearing; and
a fan supported on the bushing;
wherein the bushing includes a balancing portion that extends axially away from the fan and toward the rotor.

17. The power tool of claim 16, wherein the balancing portion is configured to have material removed therefrom to rotatably balance the rotor.

18. A power tool comprising:
a housing defining a longitudinal axis;
a motor positioned in the housing;
a battery receptacle defined by the housing, the battery receptacle being configured to receive a battery pack insertable into the housing in a direction along the longitudinal axis; and
a low friction wear member coupled to the housing proximate the battery receptacle;
wherein when the battery pack is inserted into the battery receptacle, the battery pack contacts and engages the low friction wear member to prevent abrasion between the housing and the battery pack.

19. The power tool of claim 18, wherein the low friction wear member is configured as a rod positioned within a slot defined by the battery receptacle.

20. The power tool of claim 18, wherein the low friction wear member is made from one of polytetrafluoroethylene (PTFE) or thermoplastic elastomer (TPE).
